(19) United States
(12) Patent Application Publication
(10) Pub. No.: US 2005/0142370 A1
(43) Pub. Date: Jun. 30, 2005

(54) Biaxially drawn adhesive tapes and method for producing the same

(76) Inventor: Bernhard Mussig, Seevetal (DE)

Correspondence Address: NORRIS, MCLAUGHLIN & MARCUS, PA, 875 THIRD STREET, 18TH FLOOR, NEW YORK, NY, 10022, US

(21) Appl. No.: 10/483,362

(22) PCT Filed: Jun. 12, 2002
(86) PCT No.: PCT/EP02/06428

(30) Foreign Application Priority Data
Jul. 9, 2001 (DE) 101 32 534.7

(51) Int. Cl. B05D 3/12; B32B 27/08

(52) U.S. Cl. 428/516; 427/355; 428/910

(57) ABSTRACT

A method of producing a film adhesive tape, characterized in that a composite comprising at least one extruded backing film layer and a pressure sensitive adhesive layer on one side of the backing film layer is biaxially drawn.

The invention relates to a method of producing a film adhesive tape and also to an adhesive tape so produced.

For film adhesive tapes it is usual to use biaxially drawn films from the two-step process. For reasons of cost, isotactic polypropylene and also its copolymers with ethylene have by far the greatest importance. Of lesser importance for adhesive tapes is polyester; polyamide has found only low levels of application in practice.

Drawing has an essential function: it results in adhesive tapes which are better in strength, transparency, and processing properties, both during their production and during application by the end user. Owing to the production method, however, the standard commercial products have the good mechanical qualities in transverse direction (i.e., cross direction, CD; perpendicular to the direction of drawing) instead of in the technically relevant longitudinal direction (i.e., machine direction, MD; parallel to the direction of drawing). Films of this kind are coated with the pressure sensitive adhesive in a separate operation, in the course of which, usually, further functional layers are applied as well. The principal application is as carton sealing tape (CST); other products include office and household adhesive tapes or specialty products for packing, labeling, etc.

The process steps set out below belong to the state of the art on the production of adhesive tapes from biaxially drawn film backing:

Production of a BOPP Film.

With virtually no exceptions the films employed come from the two-step process (stretching first longitudinally and then transversely), although the strength in machine direction is higher than in transverse direction. Units for a process of this kind are produced, for example, by the companies Brückner (D) or Mitsubishi (J). These units allow a polypropylene melt to be extruded onto a cooled roller (chill roll), drawing in a ratio of about 1:5 in MD and drawing in a ratio of about 1:10 in CD. The film is manufactured by the adhesive tape producer itself or acquired from a film manufacturer. The two-step process can also be carried out in reverse order, in which case better mechanical properties in MD are achieved, but the process is operationally reliable neither economically nor in great width, since drawing in MD has to be carried out in the full width; as a result, this version is utilized practically not at all. A three-step draw (drawing in MD-CD-MD) likewise provides improved strength in MD as compared with the standard two-step method, but is technically complex and is therefore of only little importance at the present time. Blown films from annular dies are of little importance despite their good mechanical properties in machine direction; this is because this process of film production is less efficient, owing to the usual small size of the unit, than the two-step process.

Polypropylene film stretched simultaneously with stretching frames (i.e., the extruded primary film is drawn simultaneously in CD and MD) has not to date acquired any practical importance for use as a backing film for adhesive tapes, since the unit technology results in relatively high operating costs for the film and the capital costs are much higher than for other methods. This applies to the technology from the company Kampf, with fixed dimensions of the stretching frame (and hence a stretching ratio which is virtually unadjustable) and the more recent linear motor technology with variable stretching ratios, from the company Brückner. The latter is employed for specialty biaxially drawn polyester films and has no market importance for PP adhesive tapes.

Stretching operations described in the literature include the blowing method (e.g., double bubble), the Kampf process (non-adjustable stretching), and, in particular, the LISIM process (linear motor drawing); e.g., J. Nentwig, Papier+Kunststoffverarbeiter page 22 issue 12 (1998), Modern Plastics page 26 March issue (1996), Kunststoffe 85 page 1314 (1995), and publications DE 37 44 854 A1 and DE 39 28 454 A1.

Coating with Pressure Sensitive Adhesive:

The film is coated with adhesive in a variety of methods. Of practical importance are hotmelt pressure sensitive adhesives based on SIS block copolymers and hydrocarbon resins, solvent-based pressure sensitive adhesives based on natural rubber, hydrocarbon resins, and hexane and/or toluene, and aqueous acrylate dispersions.

Further Functional Layers:

In some cases further functional layers are applied before or after the adhesive coating operation, examples including metallization with aluminum, priming (coating or corona treatment) to improve the adhesion of the adhesive to the film, release coating with a release agent on the reverse of the film, to aid unwinding the adhesive tape, or printing.

Converting:

The adhesive-coated film rolls (known as Jumbos) are slit to adhesive tape rolls in a further workstep and are subsequently packed.

U.S. Pat. No. 5,145,718 A describes a new process for improving the economics of manufacturing such adhesive tapes. The key concept lies in the integration of the coating of pressure sensitive adhesive and release in the process of film production by the known two-step process, with the coating in film production taking place between the steps of longitudinal drawing and transverse drawing.

It is an object of the invention to provide a method of drawing which does not have the disadvantages of the prior art and which provides, in particular, with a simple and cost-effective procedure, a high-value adhesive tape which in particular is improved in terms of its properties.

The object is achieved surprisingly by a method as set out in claim 1. The dependent claims relate to developments of said method. Further claims relate to an adhesive tape obtainable by the inventive method and to improved embodiments of said adhesive tape.

The main claim accordingly provides a method for producing a film adhesive tape, in which a composite comprising at least one extruded film backing layer and a pressure sensitive adhesive layer located on one side of the backing film layer is biaxially drawn.

The pressure sensitive adhesive layer here may be composed homogeneously of one pressure sensitive adhesive or else of two or more layer sequences of pressure sensitive adhesives.

The method of the simultaneous drawing of film backing layer and pressure sensitive adhesive layer allows film adhesive tapes to be produced with outstanding mechanical properties in machine direction and favorable costs as a result of the integration of film production and coating and possibly also winding of rolls in an in-line process. The objective of the present invention is to improve the economics and the quality of adhesive tapes having a biaxially drawn film, especially a polypropylene film. The removal of the production of films as an intermediate in roll form lowers the processing costs and prevents waste (film residues in the case of automatic roll change on the coating unit). As an essential feature of the method of the invention, pressure sensitive adhesive and film backing layer (raw film material) are biaxially drawn (stretched) simultaneously in one step. Suitable stretching processes include the blowing process (e.g., double bubble) the Kampf process (non-adjustable stretching), and in particular the LISIM process (linear motor drawing).

The primary film is produced (where appropriate at the same time as other functional layers) in a casting operation with extruder and chill roll; the coating with pressure sensitive adhesive takes place prior to simultaneous drawing in a heated stretching frame on the film (i.e., on the backing film layer or on the primer layer). Another embodiment avoids coating by carrying out coextrusion of film backing layer and pressure sensitive adhesive layer and, where appropriate, further functional layers. In the preferred form of simultaneous drawing, the stretching operation is accompanied by a continuous increase in the clip spacing by the movement of the clips in CD, as a result of which the film is, simultaneously, additionally oriented in MD. These mechanical processes can be permanently installed (Kampf Technology) or applied variably, by means for example of appropriate drives (Brückner Technology) or by means of take-off speed and blow-up ratio in the case of the blowing process. Variable orientation is extremely advantageous, since it allows the production width and the mechanical properties of the resultant film to be adapted flexibly to any application. When using blowing units it is appropriate to slit the film bubble on one or both sides, after it has been collapsed, and to coat it in one or two separate application systems. The approximately 50% greater strengths of the film or adhesive tape that result from the simultaneous stretching process, as compared with products of the same kind from the two-step process, can be utilized not only to improve the quality of the product but also to reduce the film thickness. In the case of the two-step process the strength in transverse direction (CD) is always greater than in machine direction (MD), as a result of the stretching ratios and of the fact that the memory effect of the last process step (transverse drawing) is the most highly pronounced.

Essential to the inventive method is the sufficient drawing of the adhesive tape in particular in machine direction. This implies the attainment of an overall stretching ratio of at least 1:25, preferably at least 1:40, i.e., 1:50, for example. The overall stretching ratio is the product of the drawing ratios in MD and CD. The ratio of the drawing ratio in machine direction to that in transverse direction should be above 0.6, preferably above 0.9 and more preferably above 1.2. This produces moduli at 10% elongation in accordance with DIN 53457, in MD, of at least 50, preferably at least 70 and more preferably at least 100 N/mm². The tensile strength in accordance with DIN 53455-7-5 in machine direction is at least 160, preferably at least 190, and more preferably at least 220 N/mm². In the calculation of the above characteristics, the division of the forces by the thickness is based on the thickness not of the adhesive tape but of the film backing layer. The bond strength on steel in accordance with DIN EN 1939 method ought to amount to at least 1.3 N/cm, preferably at least 1.6 N/cm, in order to achieve sufficient adhesion for packaging applications. The thickness of the adhesive tape is preferably between 35 and 65 μm, since excessive film thicknesses require high drawing forces and the adhesive tape becomes too stiff for the application, and in the case of inadequate thicknesses the adhesive tape is too easily extensible (soft).

The present invention is delimited from WO 96/37568 A1: the films specified therein are preferably undrawn, and drawing ratios of more than 1:1.2 in MD and CD are described as being disadvantageous. Moreover, the products specified in that publication are surface protection products, for which a weakly adhering composition is applied primarily by means of extrusion coating.

The present invention has its focus on packaging applications, particularly carton sealing, where effective adhesion to rough substrates and low film extensibility are required.

Like U.S. Pat. No. 5,145,718 A, the present invention achieves an improvement in productivity by integrating the production of film and the application of adhesive. However, instead of the coating of the partially drawn film with pressure sensitive adhesive and release, it allows the coextrusion of a multi-ply precursor product composed of backing (film) and pressure sensitive adhesive (PSA) and also, optionally, further functional layers such as primer and release, thereby simplifying the operation still further. This is not possible according to the process of the abovementioned US publication, since an adhesive product cannot be drawn on stretching rollers, whereas the method of the invention allows the adhesive to be drawn without contact. A further advantage of the present invention is the possibility of omitting a release. As the skilled worker is well aware, release in the case of adhesive packaging tapes, such as drawn polypropylene adhesive tapes, for example, leads to the known, unpleasant clattering noise during unwind. This can be avoided in particular by the possibility of using natural rubber and acrylate hotmelt PSAs, which are not covered by the publication referred to above. Natural rubber hotmelt PSAs are of extremely high viscosity, and so to date have not been producible in thin layers.

The new method has the advantage over the abovementioned publication that by virtue of the biaxial drawing (overall stretching ratio approximately 1:50) of such an adhesive a much thinner layer is easily obtained than by means of transverse drawing alone (draw ratio approximately 1:8). The present method also opens up the possibility, instead of winding the web of adhesive tape to a jumbo, with a subsequent slitting operation, of supplying the web, after it has passed through a storage means, to winding in end-consumer length directly—that is, either in a roll winder or in a slitting machine.

A very substantial difference from the abovementioned publication and from conventional adhesive tapes with biaxially drawn film lies in the quality, in particular the improved properties of the adhesive tape and of the film layer it comprises. Adhesive tapes with films from the usual two-step process have relatively weak mechanical properties in MD (machine direction, running direction), such as tensile strength (tearing force), 10% modulus (as a measure of the resistance to stretch distortion during unwind or application) elongation at break, whereas in transverse direction these values are always considerably better. Adhesive tapes, especially for packaging or household applications, however, are stressed in machine direction. Consequently, for applications involving heightened requirements, films drawn monoaxially (in machine direction) rather than biaxially are used. Because of the process and the raw materials used, however, films of this kind are much more expensive and have a number of technical drawbacks, such as a splicing tendency and the formation of hoops. PP films from the two-step process are commonly used for adhesive tapes with release and SIS hotmelt PSA for the lower market segment, and correspond in product construction and properties to the examples set out in abovementioned publications. Adhesive tapes comprising such films with natural rubber solvent-based adhesives or acrylate dispersion adhesives, without a release, unwind quietly, but during unwind tend to tear, owing to the high reverse-face adhesion, and must therefore be given PSAs of low performance (bond strength and shear strength). The high reverse-face adhesion leads to stretching distortion of the film during unwind; in connection with relatively soft films (low 10% moduli) from the two-step process, the adhesive is highly stressed, and as a result these products exhibit weak performance and a relatively low position in the market. This problem therefore also applies to products which have been produced in accordance with the prior art, but not to the products with superior performance in machine direction from the method of the invention with simultaneous biaxial drawing.

A number of particularly advantageous embodiments of the inventive method are described below:
One embodiment is the integration of the slitting of jumbo rolls, long rolls or other rolls in sales dimensions into the method of the invention. This allows the productivity to be increased further, and makes it easier to produce rolls with strongly adhering adhesive without a release coating. For this purpose it is possible, for example, to use slitting machines with very quick, automatic roll changeover; preference is given to the installation of a product storage device for the start and end of operation of the automatic slitter. The long roll form offers an opportunity of easier management of a broad range of dimensions.
A further particular feature of the present invention is the possibility of crosslinking the pressure sensitive adhesive in the method of the invention. Possibilities include radiation crosslinking with UV, gamma or electron beams, or chemical crosslinking. The latter is possible through continuous metered addition of crosslinkers such as epoxides, isocyanates, aziridines, etc. into the adhesive or into a primer layer, by coextrusion or coating with a composition comprising such crosslinkers, in which case the crosslinkers become active in the primer layer only following diffusion into the adhesive.
A release effect can be achieved with particular simplicity by embossing. Particularly suitable are raised structures of infinite length in machine direction (MD). Embossing has the further advantage that the stresses resulting from post-crystallization can be reduced. This can also be done by texturing or slight foaming of the composition.
Prior to drawing it is possible to apply a release layer, solventlessly in particular, to (in particular) the side of the backing film layer that faces away from the PSA layer.
Where required, prior to drawing and prior to the application of the PSA layer, it is possible to apply a primer layer, solventlessly in particular, so that there is a primer layer between the backing film layer and the PSA layer.
Physical pretreatment of the backing film layer to improve the adhesion, by means of flame, plasma or corona treatment, is advantageous.

It can be advantageous to heat-set the film backing layer of the adhesive tape.
In one of the embodiments of the inventive method the pressure sensitive adhesive is applied by lamination prior to biaxial drawing; as transfer medium it is possible to use release paper or release film or a belt of silicone or fluoropolymer. The pressure sensitive adhesive is applied from the transfer medium in the coating processes which are customary for adhesive tapes, solventlessly in particular.
A further embodiment is the coating of the adhesive from the melt by means of suitable applicator mechanisms such as nozzles or rollers.
The preferred embodiment of the application of the adhesive to the backing film layer is coextrusion. Suitable for this purpose are nozzles with a feed block; where viscosity conditions are difficult, a multi-manifold die is preferred.
The invention does not rule out the use of solvents, but in preferred embodiments the method is completely solvent-free; particular preference is given to the processing of all components from the melt, for example, the production of all layers of the composite from the melt.
It has proven advantageous to take measures against the subsequent shrinkage of the adhesive tape, which can lead to the telescoping of rolls or deformation of the paperboard core. These measures are the heat-setting of the composite (heat treatment of the adhesive tape below the crystallite melting temperature of the raw material of the film layer), the storage of jumbos before they are slit into rolls, and the use of paperboard cores which have been provided with elastic foam on the outer ply.
Following the drawing operation it is advantageous to crosslink the pressure sensitive adhesive, in particular chemically or by means of high-energy radiation.
Thereafter it has been found advantageous to wind the adhesive tape onto paperboard cores having an elastic foam lining.

The raw materials for the film can be polyesters (e.g., PET, PEN or PET copolymer), polyamides (e.g., PA 6, PA 66, PA 46), polystyrene (crystalline with syndiotactic structure or atactically amorphous), polyvinyl chloride, or other drawable polymers. Owing to the advantageous costs and high strengths, use is made primarily of polyolefins, e.g., polyethylene, polypropylene, and copolymers of ethylene or propylene. Such copolymers may have a variety of structures, e.g., random, mini-random, block, graft or homopolymers with included amorphous phases. Preference is given to partly crystalline polypropylene having a predominantly isotactic structure without comonomer or with only a small comonomer fraction, having in particular a melt index of from 1 to 10 g/10 min (measured at 230° C. and 21.6 N). Polypropylenes of this kind are described in Encycl. Polym. Sci. Technol. 13 (1988) and in Ullmann's Encyclopedia of Industrial Chemistry A21 (1992).

These raw materials can be used in each case alone or in a blend, in which case it is possible also to use the additives familiar to the skilled worker, such as pigments, fillers, antistats, antioxidants, light stabilizers, etc. Substances of this kind are described in Plastics Additives Handbook, 5^{th} edition, Hanser Publishers, Munich. For this application the addition of nucleating agent is advisable in order to reduce the subsequent shrinkage of the adhesive tape.

Suitable pressure sensitive adhesives include all common types, examples being those described in U.S. Pat. No. 5,145,718 A, including the stated additives. It is preferred to use hotmelt PSAs applied by coextrusion, extrusion coating or calender coating. Particularly suitable are adhesives based on rubber. Such rubbers can be, for example, homopolymers or copolymers of isobutylene, 1-butene, vinyl acetate, acrylic esters, butadiene or isoprene. Formulas based on acrylic esters, butadiene or isoprene are of particular interest. Emphasis should be given both to mixtures of natural rubber and resin(s) and to meltable polyacrylic esters with a block structure for physical crosslinking. With precisely these kind of formulas it is possible to find appropriate formulations which even with strong adhesion require no coating or coextrusion of release.

For the various embodiments of the inventive method, particularly in respect of the different modes of coating, the drawability of the pressure sensitive adhesive must be optimized by the choice of an appropriate formula and/or temperature regime; this means that in the case, for example, of natural rubber the Mooney value must not be too high. Preference is given, particularly in the case of coextrusion, to pressure sensitive adhesives comprising resins and a mixture of natural rubber and styrene-isoprene block copolymer rubber, since the viscosity of the adhesive layer can be adapted, via the mixture of the two rubbers, to the viscosity of the film backing layer, thereby simplifying the conduct of the operation. The processability requirements when coating, extruding or drawing can restrict the selection of PSA polymers, thus necessitating crosslinking. After the drawing operation, therefore, the adhesive can be crosslinked advantageously by means of high-energy radiation such as electron beams or UV light or by means of chemical crosslinking agents added to the adhesive or to the primer, in order to achieve the shear strength appropriate to the application (in the case of the crosslinking agent added to the primer, it later diffuses into the pressure sensitive adhesive). In the case of formulas based on natural rubber the preferred fraction of resins and plasticizers together is above 100 phr and in the case of block copolymers of isoprene and/or butadiene it is below 100 phr.

When used as pressure sensitive adhesives for adhesive packaging tapes, acrylate compositions have a high propensity toward unwanted opening of carton seals, owing to film stretch in the applicator; here, however, owing to the much higher modulus in MD as compared with products comprising film from the two-step process, a substantial improvement is achieved in the quality of CST. In the case of adhesives which are not critical in this respect, the increased modulus can be utilized for the purpose of reducing the thickness of the backing. In order to optimize the properties it is possible for the self-adhesive composition (adhesive) employed to be blended with one or more additives such as tackifiers (resins), plasticizers, fillers, pigments, UV absorbers, light stabilizers, aging inhibitors, photoinitiators, crosslinking agents or crosslinking promoters. Tackifiers are, for example, hydrocarbon resins (e.g. resins formed from unsaturated C5 or C7 monomers), terpene-phenolic resins, terpene resins from raw materials such as α- or β-pinen, aromatic resins such as coumarone-indene resins, or resins of styrene or α-methylstyrene, such as rosin and its derivatives such as disproportionate, dimerized or esterified resins, in which case it is possible to use glycols, glycerol or pentaerythritol, and also other resins (as set out, for example in Ullmanns Enzyklopädie der technischen Chemie, Volume 12, pp. 525-555 (4th Ed.), Weinheim).

Examples of suitable fillers and pigments include carbon black, titanium dioxide, calcium carbonate, zinc carbonate, zinc oxide, silicates or silica. Examples of suitable plasticizers which can be admixed include aliphatic, cycloaliphatic, and aromatic mineral oils, diesters or polyesters of phthalic acid, trimellitic acid or adipic acid, liquid rubbers (e.g. nitrile rubbers or polyisoprene rubbers), liquid polymers of butene and/or isobutene, acrylates, polyvinyl ethers, liquid resins and soft resins based on the raw materials for tackifier resins, lanolin and other waxes, or liquid silicones. Crosslinking agents are, for example, phenolic resins or halogenated phenolic resins, melamine resins, and formaldehyde resins. Examples of suitable crosslinking promoters include maleimides, allyl esters such as triallyl cyanurate, and polyfunctional esters of acrylic acid and methacrylic acid.

Since the coating or coextrusion of the adhesives can take place in 40-fold or 50-fold thickness of the application rate of the end product, it is possible to use even very high-viscosity compositions. As a result it is possible in particular to realize high-viscosity natural rubber compositions, which would be impossible to implement at an application rate of approximately 20 μm and which even at 100 μm would be difficult to implement in practice, at an application rate of approximately 1 mm with relative ease. Natural rubber compositions are of particular importance for the inventive method. The reasons for this lie in improved product quality (good tack, low noise) and considerably lower raw materials costs for the adhesive formula (rubber and the tackifiers) as compared with conventional hotmelt PSAs based on block copolymers. The relatively high layer thickness allows the use of high-value natural rubber, since the viscosity is not a critical parameter for the extrusion and/or coating. A release effect can be obtained by coating or coextrusion of known release agents (blended where appropriate with other polymers). Examples are stearyl compounds (e.g., polyvinyl stearyl carbamate, stearyl compounds of transition metals such as Cr or Zr, ureas formed from polyethyleneimine and stearylisocyanate, polysiloxanes (e.g., as a copolymer with polyurethanes as a graft copolymer on polyolefin), and thermoplastic fluoropolymers. The term “stearyl” stands as a synonym for all linear or branched alkyls or alkenyls having a carbon number of at least 10, such as octadecyl, for example.

As primers it is possible to use the known dispersion systems and solvent systems. In the case of the coextrusion of such a layer appropriate examples include maleic anhydride-grafted polyolefins, ionomers, copolymers of styrene with butadiene or isoprene, amorphous polyesters, chlorinated polyolefins, polypropylene block copolymers with a very high comonomer fraction, or mixtures of PP with PE copolymers of very low density or EPM/EPDM.

The invention further provides a biaxially drawn film adhesive tape obtainable by the inventive method or by one of its developments, and composed of a composite comprising at least one extruded backing film layer and a pressure sensitive adhesive layer on one side of the backing film layer.

The pressure sensitive adhesive layer here can be composed of a single pressure sensitive adhesive or else of two or more individual layers, in which case a layer sequence of this kind can also be composed of different adhesives.

The film backing layer advantageously comprises at least one nucleating agent. The film backing layer is preferably composed predominantly of isotactic polypropylene. It is also of advantage if the film backing layer comprises polypropylene having a melt index of from 1 to 10 g/10 min. Advantageously the backing layer has been stretched such that the stress at 10% elongation in machine direction is at least 50 N/mm², preferably at least 70 N/mm², and very preferably at least 100 N/mm². With further advantage the backing layer has been stretched such that the tensile strength in machine direction is at least 160 N/mm², preferably at least 190 N/mm², very preferably at least 220 N/mm².

In a further advantageous embodiment of the adhesive tape the film backing layer is composed predominantly of polyethylene terephthalate.

It is of advantage for the film adhesive tape if the pressure sensitive adhesive layer comprises natural rubber and/or at least one styrene-isoprene block copolymer. It is additionally advantageous if the pressure sensitive adhesive layer comprises at least one resin.

The bond strength on steel is advantageously at least 1.3 N/cm, preferably at least 1.6 N/cm, and the thickness of the film adhesive tape is advantageously at least 35 mm, preferably between 35 mm and 65 mm.

### EXAMPLES

The aim of the text below is to illustrate the invention by means of a series of examples, without wishing to restrict the invention unnecessarily through the choice of samples investigated.

Test Methods

The measurement results quoted in the examples were determined under standard conditions in accordance with DIN 50014-23/50—Part 1.

The bond strength on steel or on the reverse face of the backing was determined in accordance with DIN EN 1939.

The application rate was determined by differential weighing, after removal of the adhesive by washing with hexane.

The Mooney viscosity was used to characterize the rubber. The Mooney viscosity was tested in accordance with ASTM D 1646.

The mechanical data were determined in accordance with DIN 53455-7-5, with measurement taking place at the earliest after one week, so that the film was in its end state (post-crystallization).

The melt indices were measured in accordance with ISO 1133 at 230° C. and 21.6 N.

The viscosity of a 1% strength solution of natural rubber in toluene was measured in a Vogel-Ossag viscometer in accordance with DIN 51561. The calculation of the K value from the relative viscosity is described in Fikentscher, Cellulose-Chemie 13 (1932), p. 58 ff. and Polymer 8 (1967), p. 381 ff., and was carried out correspondingly.

### EXAMPLES INVESTIGATED

### Example 1

On a Kampf unit (Flex-lip nozzle width 500 mm, chill roll with waterbath, throughput approximately 1200 kg/h), a PP homopolymer having a melt index of 8 g/10 min (Daplen KF 201) was extruded with the addition of 2000 ppm of 3,4-dimethyldibenzylidenesorbitol as nucleating agent, the extrudate was cooled on the chill roll (diameter 2500 mm), and wiped with a chlorine-containing polymer primer (Superchlon™) using a felt doctor, and a short way later, following venting of the primer, was coated from a melt die with an acrylate block copolymer (butyl acrylate co-methylmethacrylate). This composite ran through the simultaneous stretching apparatus at an oven temperature of 160° C. and was wound up at 70 m/min. The stretching ratio was 1:7 lengthwise and 1:7.5 transversely. The rollers which came into contact with adhesive were masked beforehand with an adhesive tape having a silicon rubber surface.

The product obtained has the following data:
Bond strength on steel: 3.5 N/cm
Adhesive application rate: 30 g/m²
Film thickness: 40 μm
Stress at 10% elongation in MD: 77 N/mm²
Tensile strength in MD: 172 N/mm²

### Example 2

On a Triplex film blowing unit with a film bubble extent of 1.5 m, three layers were coextruded:
A=isotactic PP homopolymer having a melt index of 3 g/10 min (Exxon PP 4352 F3) with the addition of 2500 ppm of MDBS as nucleating agent
B=Copolymer of ½ each EVA copolymer (ethylene vinyl acetate) with 28% VA (vinyl acetate) (Escorene UL 728) and PP block copolymer with about 6.5% ethylene (Novolen 2309 L)
C=EVA copolymer with 45% EVA (Levapren 450, the melt index was measured for this batch, according to the manufacturer, at 3 g/10 min at 190° C.)

The film bubble was slit on both sides, wound up and cut into rolls. Owing to the tendency of the rolls to telescope, paperboard cores with an outer layer of PE foam 2 mm thick were used. The adhesive-contacting parts of the unit were made of Teflon or silicone.

The product obtained has the following data:
Bond strength on steel: 1.1 N/cm (lengthwise)
Thickness of adhesive: 20 μm
Primer thickness: 5 μm
Film thickness: 30 μm
Stress at 10% elongation in MD: 95 N/mm²
Tensile Strength in MD: 211 N/mm²

The thicknesses were determined microscopically following microtome section.

### Example 3

On a LISIM unit a PP homopolymer having a melt index of 2 g/10 min (Inspire H301-02AS) and a compound (made up of 90% by weight of the above polymer and 10% by weight of polyvinyl stearyl carbamate) were coextruded at 198° C. and the extrudate was cooled on a chill roll, corona treated on the pure PP side, then coated from a melt die with an SIS hotmelt PSA (consisting of 100 phr SIS Vector 4111, 110 phr resin Escorez 2203, 10 phr plasticizer Flexon 876 and 2 phr antioxidant Irganox 1010); this composite ran through the simultaneous stretching apparatus at an oven temperature of 155° C. and was wound at 20 m/min. The stretching ratio was 1:9 lengthwise and 1:5 transversely. The rolls which came into contact with the adhesive were masked beforehand with an adhesive tape having a silicone rubber surface.

The product obtained has the following data:
Bond strength on steel: 5.5 N/cm
Adhesive application rate: 19 g/m²
Thickness of the film backing layer: 30 μm
Thickness of the release layer: 1 μm
Stress at 10% elongation in MD: 110 N/mm²
Tensile strength in MD: 250 N/mm²

The thicknesses were calculated from the total thickness of 31 μm and the extruder ejection performances.

### Example 4

The specimen was produced as in example 3 but with the following changes:
additional coextrusion layer as primer (PP Elastomer HiFax CA 10 A),
no corona treatment.

The product obtained has the following data:
Bond strength on steel: 5.2 N/cm
Adhesive application rate: 20 g/m²
Thickness of the film backing layer: 30 μm
Thickness of the release layer: 1 μm
Thickness of the primer layer: 2 μm
Stress at 10% elongation in MD: 110 N/mm²
Tensile strength in MD: 250 N/mm²

### Example 5

A PP copolymer with about 2% ethylene and having a melt index of 5 g/10 min was extruded in the thickness of 1.5 mm, flame-pretreated on one side and laminated with a film of adhesive 1 mm thick. The film of adhesive was produced by calendering and had the following composition: 45% by weight of natural rubber having a Mooney value of 46, 1.4% by weight of antioxidant BKF, 33.21% by weight of Hercotac 205, 0.39% by weight of Suprasec DNR, 12% by weight of lanolin and 8% by weight of Avana batch pigment (iron oxides and titaniun dioxide with a rosin ester binder). Both components were used in the fresh state. The specimen was cut into squares and, following preheating for 60 seconds, was simultaneously drawn at 180° C.; the draw ratio was set at 1:7 in both directions. The resulting sample was cut into strips 15 mm wide, which were wound up by hand to give a small sample roll. After four weeks of storage at room temperature the sample could be unwound quietly and without disruption, and had the following data:
Bond strength on steel: 1.6 N/cm
Adhesive application rate: 25 g/m²
Film thickness: 30 μm
Stress at 10% elongation in MD: 65 N/mm²
Tensile strength in MD: 160 N/mm²

When this experiment was repeated with a high molecular mass rubber (RSS1, Mooney value 93) the adhesive layer underwent partial detachment from the substrate in the course of drawing, and had cracks in it.

### Example 6

A three-layer film with the following construction was coextruded:
Compound made up of 90% by weight PP homopolymer having a melt index of 2 g/10 min and 10% by weight polyvinyl stearyl carbamate (0.1 mm)
PP homopolymer having a melt index of 2 g/10 min (1.5 mm)
PP elastomer HiFax (0.1 mm)
SIS hotmelt pressure sensitive adhesive composed of 50 phr SIS Vector 4111, 50 phr natural rubber (K value according to Fikentscher), 110 phr resin Escorez 2203, 10 phr plasticizer Flexon 876, and 2 phr antioxidant Irganox 1010 (1.0 mm)

The thickness of the individual layers was determined by microscopic inspection and is indicated in brackets. The sample was cut up into squares and, following 60 seconds of preheating at 158° C., were drawn simultaneously; the draw ratio was set at 1:6.9 in both directions. The sample obtained was cut into strips 15 mm wide which were wound up by hand to form a small sample roll.

### Example 7

Polyethylene terephthalate granules were freed from moisture in a vacuum drying cabinet and extruded to a film on a chill roll at a temperature of 20° C. Following pretreatment with an aqueous primer based on PVDC (Haloflex) a melt die was used to apply an acrylate pressure sensitive adhesive having a K value of 78 (composition: 48% by weight butyl acrylate, 48% by weight ethylhexyl acrylate, and 4% by weight acrylic acid). This composite was drawn simultaneously at 130° C., the draw ratio was set at 1:3.6 in both directions, and the composite was subsequently heat-set at 220° C. The specimen has the following data:
Bond strength on steel: 4 N/cm
Adhesive application rate: 25 g/m²
Film thickness: 25 μm
Stress at 10% elongation in MD: 120 N/mm²
Tensile strength in MD: 160 N/mm²

### Comparative Example 1

A film (35 MB 250 from Mobil Plastics) from the 2-step stretching process was coated as described in example 3 on a production unit with polyvinyl stearyl carbamate (from toluene) and with a hotmelt PSA.

The specimen has the following data:
Bond strength on steel: 5.3 N/cm
Adhesive application rate: 23 g/m²
Film thickness: 35 μm
Stress at 10% elongation in MD: 50 N/mm²
Tensile strength in MD: 145 N/mm²

### Comparative Example 2

A film (PP 28 μm from Pao Yan) from the 2-step stretching process was coated as described in example 3 on a production unit with polyvinyl stearyl carbamate (from toluene) and with a hotmelt PSA.

The specimen has the following data:
Bond strength on steel: 5.0 N/cm
Adhesive application rate: 19 g/m²
Film thickness: 28 μm
Stress at 10% elongation in MD: 46 N/mm²
Tensile strength in MD: 150 N/mm²

### Comparative Example 3

A film (Torayfan YT 40 μm from Toray) from the 2-step stretching process was coated as described in example 3 on a production unit with polyvinyl stearyl carbamate (from toluene) and with a hotmelt PSA.

The specimen has the following data:
Bond strength on steel: 6.0 N/cm
Adhesive application rate: 22 g/m²
Film thickness: 40 μm
Stress at 10% elongation in MD: 40 N/mm²
Tensile strength in MD: 65 N/mm²

### Comparative Example 4

Patent example 1 of U.S. Pat. No. 5,145,718 was repeated, but using polyvinyl stearyl carbamate because the release described was not obtainable. The sample has the following data:
Bond strength on steel: <1 N/cm
Adhesive application rate: 2 g/m²
Film thickness: 30 μm
Stress at 10% elongation in MD: 50 N/mm²
Tensile strength in MD: 155 N

1. A method of producing a film adhesive tape, said method comprising biaxially drawing a composite comprising at least one extruded backing film layer and a pressure sensitive adhesive layer adhered directly or indirectly on one side of the backing film layer.

2. The method of claim 1, wherein the composite comprises a primer layer between the backing film layer and the pressure sensitive adhesive layer there is a primer layer.

3. The method of claim 1, wherein the composite comprises a release layer on a side of the backing film layer opposite the side of the backing film layer to which said pressure sensitive adhesive layer adhered.

4. The method of claim 1, wherein the film backing layer of the adhesive tape is heat-set.

5. The method of claim 1, which further comprises heat-setting the composite after drawing.

6. The method of claim 1, wherein the pressure sensitive adhesive is applied to the backing film layer by melt coating.

7. The method of claim 1, wherein the pressure sensitive adhesive is applied to the backing film layer by coextrusion.

8. The method claim 1, wherein the pressure sensitive adhesive is applied by lamination to the backing film layer or to the primer layer prior to drawing.

9. The method of at claim 1, which further comprises producing all layers of the composite by a solvent-free procedure from a melt.

10. The method of claim 1, wherein the pressure sensitive adhesive is crosslinked chemically or by means of high-energy radiation.

11. The method of claim 1, wherein the drawing is carried out on a unit with linear motor technology.

12. The method of at claim 1, which further comprises supplying the composite after drawing in an in-line operation to a roll winder or to a slitting machine.

13. The method of claim 1, which further comprises supplying the composite overall draw ratio of at least 1:40.

14. The method of claim 1, which exhibits a the ratio of a draw ratio in a machine direction to a draw ratio in transverse a direction is above 0.9.

15. The method of claim 1, which further comprises winding the adhesive tape onto paperboard cores with an elastic foam lining.

16. A biaxially drawn film adhesive tape obtainable according to the method of claim 1, said biaxially drawin film adhesive tape being composed of a composite comprising at least one extruded backing film layer and a pressure sensitive adhesive layer adhered directly or indirectly on one side of the backing film layer.

17. The film adhesive tape of claim 16, wherein the film backing layer comprises at least one nucleating agent.

18. The film adhesive tape of claim 16, wherein the film backing layer is composed predominantly of isotactic polypropylene.

19. The film adhesive tape of claim 16, wherein the film backing layer comprises polypropylene having a melt index of from 1 to 10 g/10 min.

20. The film adhesive tape of claim 16, wherein the backing layer is stretched such that the stress at 10% elongation in machine direction is at least 50 N/mm².

21. The film adhesive tape of claim 16, wherein the backing layer is stretched such that the tensile strength in a machine direction is at least 160 N/mm2.

22. The film adhesive tape of claim 16, wherein the film backing layer is composed predominantly of polyethylene terephthalate.

23. The film adhesive tape claim 16, wherein the pressure sensitive adhesive layer comprises natural rubber.

24. The film adhesive tape of claim 16, wherein the pressure sensitive adhesive layer comprises at least one styrene-isoprene block copolymer.

25. The film adhesive tape of claim 16, wherein the pressure sensitive adhesive layer comprises at least one resin.

26. The film adhesive tape of claim 16, which exhibits a bond strength on steel of at least 1.3 N/cm.

27. The film adhesive tape of claim 16, which has a thickness of at least 35 mm.

28. The film adhesive tape claim 16, wherein the backing layer is stretched such that the stress at 10% elongation in machine direction is at least 70 N/mm².

29. The film adhesive tape claim 28, wherein the backing layer is stretched such that the stress at 10% elongation in machine direction is at least 100 N/mm².

30. The film adhesive tape of claim 21, wherein the backing layer is stretched such that the tensile strength in a machine direction is at least 190 N/mm2.

31. The film adhesive tape of claim 30, wherein the backing layer is stretched such that the tensile strength in a machine direction is at least 220 N/mm2.

32. The film adhesive tape of claim 16, which exhibits a bond strength on steel of at least 1.6 N/cm.

33. The film adhesive tape of claim 27, which has a thickness of between 35 mm and 65 mm.

34. A film adhesive tape comprising a biaxially drawn composite, wherein the composite comprises at least one extruded backing film layer and a pressure sensitive adhesive layer adhered directly or indirectly on one side of the backing layer.

35. A method of producing an adhesive bond comprising adhering a film adhesive tape according to claim 16 to a substrate.

36. A method of producing an adhesive bond comprising adhering a film adhesive tape according to claim 34 to a substrate.
